(19) United States
(12) Patent Application Publication
(10) Pub. No.: US 2024/0426363 A1
(43) Pub. Date: Dec. 26, 2024

(54) VALVE ASSEMBLY FOR A VIBRATION DAMPER, AND VIBRATION DAMPER COMPRISING THE VALVE ASSEMBLY

(71) Applicant: ZF FRIEDRICHSHAFEN AG, Friedrichshafen (DE)

(72) Inventors: Björn ANDRE, Rimpar (DE); Steffen SIEGLER, Zellingen (DE); Manuel TREUBERT, Oberthulba (DE); Ralf HOPFENGART, Prichsenstadt (DE)

(21) Appl. No.: 18/695,913

(22) PCT Filed: Sep. 28, 2022
(86) PCT No.: PCT/EP2022/076940

§ 371 Date: Mar. 27, 2024

(30) Foreign Application Priority Data
Oct. 4, 2021 (DE) 10 2021 211 165.3

(51) Int. Cl. F16F 9/516; F16F 9/34; F16F 9/348

(52) U.S. Cl. CPC F16F 9/516; F16F 9/341; F16F 9/348; F16F 2222/12; F16F 2228/066

(57) ABSTRACT

A vibration damper valve assembly having a main valve, a main valve body, a main valve disc influencing a main volumetric flow resistance, and an additional draw-side and pressure-side valve. The draw-side additional valve has a draw-side additional valve body and a draw-side valve disc influencing an auxiliary volumetric flow resistance on the draw side, and the pressure-side additional valve has a pressure-side additional valve body and a pressure-side valve disc influencing the auxiliary volumetric flow on the pressure side. A support section axially secures the main valve and the two additional valves. The main valve body is arranged between the additional valve bodies defining a draw-side and a pressure-side working chamber. The pressure-side additional valve opens into a pressure chamber chambered off relative to the pressure-side working chamber, and the working chamber is delimited by an additional valve disc to influence the flow resistance of the auxiliary volumetric flow.

### CROSS REFERENCE TO RELATED APPLICATIONS

This is a U.S. national stage of Application No. PCT/EP2022/076940 filed Sep. 28, 2022. Priority is claimed on German Application No. DE 10 2021 211 165.3 filed Oct. 4, 2021, the content of which is incorporated herein by reference.

### BACKGROUND OF THE INVENTION

### 1. Field of the Invention

The present disclosure relates to a valve assembly and to a vibration damper having the valve assembly.

### 2. Description of the Related Art

Particularly in the vehicle sector, vibration dampers are usually used in combination with a spring system in the running gear of a vehicle. Vibration dampers of this kind are generally formed by two damper parts that are capable of movement relative to one another and are usually hydraulically damped with respect to one another. By virtue of the fundamental construction of hydraulic dampers, energy conversion is accomplished by converting kinetic energy into heat by the action of shear, and it is possible during this process, depending on the character of the damper characteristic, that flow noises may occur.

DE 10 2014 205 855 A1 discloses a damping valve device for a vibration damper, comprising a main valve body, a first auxiliary valve body, and a second auxiliary valve body with at least two through-flow channels connected hydraulically in parallel for a flow direction of a damping medium, wherein outlet cross sections of the at least two through-flow channels are each influenced by at least one valve disk, wherein the valve bodies are axially fastened to a common support. The support extends through the valve bodies, wherein at least one of the through-flow channels is formed on the support. The damping device has a first auxiliary valve, comprising the first auxiliary valve body and at least one first valve disk, and a second auxiliary valve, comprising the second auxiliary valve body and at least one further, separate valve disk, which are connected by a common through-flow channel and are thus connected hydraulically in series such that the flow rate of the damping medium flowing through the second auxiliary valve is limited by the first auxiliary valve.

### SUMMARY OF THE INVENTION

A problem addressed in this disclosure is providing a valve assembly of the type stated at the outset which is distinguished by reduced noise generation.

One aspect of the invention is a valve assembly designed and/or suitable for a vibration damper. The valve assembly is preferably used to adjust a damping force of the vibration damper. In particular, the valve assembly is coupled to the motion of a piston rod of the vibration damper, such that, when there is a movement of the piston rod in the tension or compression direction, the valve assembly follows this movement.

The valve assembly has a main valve, wherein the main valve has a main valve body and at least one or precisely one main valve disk for influencing a flow resistance of a main volumetric flow. The main valve preferably has at least one or precisely one main valve disk for implementing tension-stage damping and at least one or precisely one further main valve disk for implementing compression-stage damping. In other words, the damping force in the tension direction can be influenced and/or controlled by at least one main valve disk, and the damping force in the compression direction can be influenced and/or controlled by at least one further main valve disk.

In particular, the main valve body has one or more main flow channels, wherein the at least one main valve disk is designed to change and/or restrict the free opening cross section of the main flow channel. The main valve body preferably has one or more tension-side main flow channels and one or more compression-side main flow channels, wherein, during a tension movement, the main volumetric flow runs via the tension-side main flow channel and, during a compression movement, it runs via the compression-side main flow channel. More specifically, at least one main valve disk covers the tension-side main flow channel in such a way that the tension-side main flow channel is opened during the tension movement and closed during the compression movement. More specifically, at least one main valve disk covers the compression-side main flow channel in such a way that the compression-side main flow channel is opened during the compression movement and closed during the tension movement. In particular, the main valve disks are each formed by a spring disk. More specifically, a plurality of the spring disks can be combined to form a spring disk assembly.

The valve assembly has a tension-side and a compression-side auxiliary valve. The tension-side auxiliary valve has a tension-side auxiliary valve body and at least one or precisely one tension-side auxiliary valve disk, which is designed and/or is suitable for influencing a flow resistance of a secondary volumetric flow on a tension side. The compression-side auxiliary valve has a compression-side auxiliary valve body and at least one or precisely one compression-side auxiliary valve disk, which is designed and/or is suitable for influencing a flow resistance of the secondary volumetric flow on a compression side. In particular, preferably during a tension movement, the secondary volumetric flow runs via the two auxiliary valves in parallel with the main volumetric flow. The compression-side auxiliary valve and the tension-side auxiliary valve are preferably connected hydraulically in series, such that the flow rate of the damper fluid flowing through one auxiliary valve is limited by the other auxiliary valve. In principle, the tension-side and/or the compression-side auxiliary valve disk can be designed as a spring disk. Alternatively, however, the tension-side and/or the compression-side auxiliary valve disk may also be formed by cover disks, which are preferably rigid and/or non-deformable.

The valve assembly has a support section, which is designed and/or suitable for axially securing the main valve body and the two auxiliary valve bodies. In particular, the main valve body and the two auxiliary valve bodies are secured positively and/or nonpositively on the support section, at least in the axial direction. The support section is preferably formed by a piston rod, which is guided in at least one damper tube in the axial direction with respect to the main axis. The piston rod preferably defines the main axis, preferably with its longitudinal axis. The valve bodies fixed on the common support section are preferably axially braced against one another, at least indirectly, by a common fastening.

The main valve body is arranged on the support section axially between the two auxiliary valve bodies and defines a tension-side and a compression-side working space. Preferably, the tension-side working space is to be interpreted as a working space on the piston-rod side, and the compression-side working space is to be interpreted as a working space on the side remote from the piston rod. In this case, the tension-side auxiliary valve is arranged in the tension-side working space (tension side), and the compression-side auxiliary valve is arranged in the compression-side working space (compression side). In particular, the main valve body is guided in a sealed manner in the radial direction on an inner circumference of the damper tube, wherein the two working spaces are bounded by the main valve body in the axial direction and by the damper tube in the radial direction with respect to the main axis. The two working spaces are filled at least partially or completely with a damper fluid, preferably a hydraulic fluid.

According to one aspect of the invention, it is proposed that the compression-side auxiliary valve opens into a pressure chamber, which is chambered off relative to the compression-side working space. Here, the pressure chamber has the function of changing a speed of flow and/or a direction of flow of the secondary volumetric flow and/or of generating an additional flow resistance downstream of the compression-side auxiliary valve. In this case, the pressure chamber should be interpreted to mean an annular space which encircles the main axis and is delimited and/or bounded in terms of flow with respect to the compression-side working space. As a particular preference, the secondary volumetric flow runs via the pressure chamber into the compression-side working space after the compression-side auxiliary valve.

According to one aspect of the invention, the pressure chamber is bounded in an axial direction with respect to the main axis, in particular in the direction of compression, by a further valve disk, which is designed and/or suitable for influencing the flow resistance of the secondary volumetric flow into the compression-side working space. The further valve disk preferably has a restricting and/or a nonreturn function. The further valve disk is preferably formed by a spring disk, which generates a variable flow resistance. In particular, the spring disk is elastically deformed as a function of the secondary volumetric flow on account of a fluid pressure built up in the pressure chamber in order to alter the flow resistance and/or to change or expose an opening cross section. Alternatively, however, the further valve disk can also be formed by a, preferably rigid and/or non-deformable, cover disk, which generates a constant flow resistance.

Thus, a valve assembly with a multistage damping force characteristic is provided, wherein the flow noises at all damper speeds can be significantly reduced by a multistage pressure reduction of the secondary volumetric flow. In particular, the chambering of the auxiliary valve generates an additional flow resistance, which brings about a reduction in the pressure difference between the emerging damper fluid from the compression-side auxiliary valve within the pressure chamber and the damper fluid at low pressure within the compression-side working space. This produces an additional pressure reduction within the pressure chamber and thereby reduces noise emissions by the compression-side auxiliary valve.

According to one aspect of the invention, it is envisaged that the two auxiliary valves are connected to one another fluidically by a secondary flow channel connected hydraulically in parallel with the main flow channel. In particular, the secondary flow channel is formed on the support section and/or formed jointly by the support section. The support section can have a cylindrical external shape, wherein the flow channel formed on the support section is implemented by a partial flattening of the support section. When there is a movement of the valve assembly in a tension direction, the secondary volumetric flow runs from the tension-side working space, via the tension-side auxiliary valve, the secondary flow channel, via the compression-side auxiliary valve into the pressure chamber and from the pressure chamber into the compression-side working space, wherein the flow rate of the secondary volumetric flow is limited by the further valve disk. Thus, an additional flow resistance for the damper fluid flowing through the compression-side auxiliary valve is generated by the further valve disk. By the additional pressure reduction, it is thus possible to reduce the flow noises.

As an option, the valve assembly has at least one or precisely one compensating disk for setting a preload of the further valve disk, in particular the further valve disk designed as a spring disk, wherein the preload enables the flow rate or the flow resistance to be set. In particular, it is possible to set the noise behavior to an optimum through a combination of the preload and the cover disk thickness. Moreover, through the arrangement of one or more compensating disks, it is also possible to compensate for component tolerances.

According to one aspect of the invention, it is envisaged that the compression-side auxiliary valve body and/or the compression-side auxiliary valve disk have/has at least one or precisely one radial outflow channel for the formation of a radial flow path for the secondary volumetric flow, wherein the secondary volumetric flow runs at least partially via the radial outflow channel into the pressure chamber. In particular, the radial outflow channel makes it possible to ensure a constant flow from the secondary flow channel into the pressure chamber, thereby enabling the vibration damper to be fitted by hand. In other words, the radial outflow channel serves to bridge the compression-side auxiliary valve disk at low speeds of the vibration damper in the tension direction and in the compression direction. The radial outflow channel can preferably be formed by a groove, depression, notch, cutout, bore or the like introduced into the compression-side auxiliary valve body. By virtue of the arrangement of the radial outflow channel in the compression-side auxiliary valve body, said body has no effect on the disk thickness of the compression-side auxiliary valve disk and thus on the damper characteristic. As an alternative or optional addition, the radial outflow channel is formed by an aperture, cutout, bore, stamped feature or the like introduced into the compression-side auxiliary valve disk. By virtue of the arrangement of the radial outflow channel in the compression-side auxiliary valve disk, it is possible to use a defined selection of valve disks from the existing valve kit

Alternatively, however, it is also possible to envisage that the main valve body on the compression side and/or the compression-side main valve disk have/has at least one or precisely one radial outflow channel for the formation of a radial flow path for the main volumetric flow, wherein the main volumetric flow runs at least partially via the radial outflow channel into the compression-side working space during a tension movement. Thus, fitting of the piston rod by hand can be ensured by a constant flow from the tension-side into the compression-side working space via the main valve.

According to one aspect of the invention, it is envisaged that the pressure chamber is bounded in a radial direction with respect to the main axis by a cylindrical shell section. In this case, the cylindrical shell section has on its axial end an encircling valve seat surface for contact with the further valve disk. In particular, the cylindrical shell section is arranged coaxially with respect to the main axis in the compression-side working space and delimits the pressure chamber within the compression-side working space. Particularly in a state of rest of the vibration damper, the further valve disk preferably rests at the edge and/or circumferentially against the valve seat surface.

According to one aspect of the invention, it is envisaged that the pressure chamber is connected fluidically to the compression-side working space via at least one axial outflow channel for the formation of an axial flow path for the secondary volumetric flow. In particular, the secondary volumetric flow in the axial direction runs at least partially via the axial outflow channel into the compression-side working space. The further valve disk and/or the cylindrical shell section preferably have/has the at least one axial outflow channel. The axial outflow channel makes it possible to ensure a constant flow from the pressure chamber into the compression-side working space, thereby enabling the vibration damper to be fitted by hand. In other words, the axial outflow channel serves to bridge the further valve disk at low speeds of the vibration damper in the tension direction. The axial outflow channel can preferably be formed by an aperture, bore, cutout or the like introduced into the further valve disk or the cylindrical shell section. The axial outflow channel prevents a flow directed toward the damper tube and thereby reduces vibrational excitation of the damper tube. By the additional pressure reduction, it is thus possible to further reduce the flow noises.

According to one aspect of the invention, it is envisaged that the pressure chamber is connected fluidically to the compression-side working space via at least one or precisely one further radial outflow channel for the formation of a radial flow path for the secondary volumetric flow. In particular, the secondary volumetric flow in the radial direction runs at least partially via the further radial outflow channel into the compression-side working space. The further valve disk and/or the cylindrical shell section preferably have/has the further radial outflow channel. The further radial outflow channel can be arranged in the further valve disk or the cylindrical shell section as an alternative or optional addition to the axial outflow channel. The further radial outflow channel makes it possible to ensure a constant flow from the pressure chamber into the compression-side working space, thereby enabling the vibration damper to be fitted by hand. In other words, the further radial outflow channel serves to bridge the further valve disk at low speeds of the vibration damper in the tension direction. The further radial outflow channel can preferably be formed by a groove, depression, notch, cutout, bore or the like introduced into the further valve disk and/or into the cylindrical shell section, in particular the valve seat surface. By the further radial outflow channel it is possible to implement an additional deflection of the flow direction of the secondary volumetric flow, e.g. by 90 degrees and thus an increase in the flow loss coefficient. By the additional pressure reduction, it is thus possible to further reduce the flow noises. Furthermore, simple component manufacture can be achieved. Moreover, the interrupted contact circle of the valve seat surface enables the vibration damper to be fitted by hand during final assembly of a vehicle.

According to one aspect of the invention, it is envisaged that an encircling annular trough is formed within the pressure chamber between the compression-side auxiliary valve body and the cylindrical shell section, wherein a flow direction of the secondary volumetric flow within the pressure chamber is deflected by the annular trough. The annular trough preferably has a constant cross-sectional profile and/or a constant radial width. The annular trough is preferably bounded in the radial direction, on the one hand by an outer circumferential surface of the compression-side auxiliary valve body and, on the other hand, by an inner lateral surface of the cylindrical section. The annular trough can preferably be used to enable a deliberate deflection of the secondary volumetric flow after the compression-side auxiliary valve in order to calm the oil flow and increase the flow loss coefficient. By the additional pressure reduction, it is thus possible to further reduce the flow noises. Furthermore, the annular trough serves for the optimum distribution of the damper fluid within the pressure chamber.

According to one aspect of the invention, it is envisaged that at least an inner edge of the cylindrical shell section has a rounding. In particular, at least within the pressure chamber, the valve seat surface is connected by the rounding to the inner lateral surface of the cylindrical shell section. In particular, the rounding is formed by a radius. Alternatively, however, the inner edge of the cylindrical shell section can also have a chamfer. As an option, an outer edge of the cylindrical shell section can have a further rounding or a further chamfer. By the rounding of the inner edge of the cylindrical shell section, the flow noises, especially as the damper fluid is flowing out via the valve seat surface, can be further reduced.

According to one aspect of the invention, it is envisaged that the valve assembly has a cylinder pot for the formation or partial formation of the pressure chamber. The compression-side auxiliary valve body is accommodated in the cylinder pot, wherein the cylinder pot has the cylindrical shell section. The cylinder pot is a component that is formed separately from the compression-side auxiliary valve body. The cylinder pot is preferably arranged on the support section and/or fixed on the support section between the main valve and the compression-side auxiliary valve in the axial direction with respect to the main axis, wherein the pressure chamber is bounded in the opposite axial direction by the cylinder pot. As a particular preference, the cylinder pot has a bottom section for bounding the pressure chamber in the opposite axial direction, wherein the cylindrical shell section directly adjoins the bottom section in the axial direction. In principle, the compression-side auxiliary valve body can be supported directly on the cylinder pot in the opposite axial direction. Alternatively, at least one compensating disk is arranged between the compression-side auxiliary valve body and the cylinder pot. The valve assembly proposed is therefore one in which one or more compensating disks can be inserted variably between the compression-side auxiliary valve body and the cylinder pot. This enables the installation of the compression-side auxiliary valve to be reliably ensured and enables component tolerances to be compensated for in a simple manner.

According to one aspect of the invention, it is envisaged that the pressure chamber is partially formed by the compression-side auxiliary valve body, wherein the compression-side auxiliary valve body has the cylindrical shell section. In particular, the compression-side auxiliary valve body and the cylindrical section form a common component. For this purpose, the compression-side auxiliary valve body and the cylindrical section are preferably manufactured from a common section of material, preferably in one piece. As a particular preference, the compression-side auxiliary valve body has the bottom section, wherein the cylindrical shell section directly adjoins the bottom section in the axial direction. The pressure chamber is preferably bounded in the opposite axial direction by the compression-side auxiliary valve body. The valve assembly proposed is therefore one which is distinguished by a reduction in the assembly effort and the effects of tolerances on account of a smaller number of components and a reduced number of interfaces relative to the multipart configuration.

According to one aspect of the invention, it is envisaged that the main valve body has a receiving space, in particular a cylindrical receiving space, on the compression side. The main valve opens on the compression side into the receiving space, wherein the receiving space is bounded by the bottom section of the compression-side auxiliary valve in order to influence a flow resistance of the main volumetric flow in the axial direction. The receiving space serves, in particular, to receive the main valve disk and the compression-side auxiliary valve. The compression-side auxiliary valve is preferably accommodated at least partially in the receiving space, in particular at least with the bottom section. In particular, the receiving space should be interpreted to mean an annular space encircling the main axis, which is delimited at least partially by the bottom section with respect to the compression-side working space. As a particular preference, the main volumetric flow during a tension movement runs into the compression-side working space via the receiving space after the main valve. The outside diameter of the cylindrical shell section is preferably larger than the valve seat surface of the main valve, in particular of the compression-side main valve disk, with the result that the main volumetric flow is deflected and/or influenced by the bottom section. The bottom section forms an additional flow resistance for the damper fluid flowing via the main valve, in particular the compression-side main valve disk. This produces an additional pressure reduction within the receiving space and thereby reduces noise emissions by the main valve.

According to one aspect of the invention, it is envisaged that either the compression-side auxiliary valve body or the cylinder pot has the bottom section. In particular, the cylinder pot or the compression-side auxiliary valve body is arranged in the receiving space in such a way that the receiving space is partially bounded by the bottom section in the axial direction. In other words, the cylinder pot or the compression-side auxiliary valve body is accommodated with a certain clearance in the receiving space, with the result that the receiving space is bounded by the bottom section but a fluidic connection is still formed between the receiving space and the compression-side working space. Depending on the configuration of the compression-side auxiliary valve, partial chambering of the main valve by the bottom section of the cylinder pot or of the compression-side auxiliary valve body is thus achieved.

According to one aspect of the invention, it is envisaged that the receiving space is bounded in the radial direction by a piston skirt section of the main valve body. In this case, an encircling annular gap for fluidically connecting the receiving space is formed between the cylindrical shell section and the piston skirt section. In particular, a speed of flow of the main volumetric flow is changed by the annular gap. In this case, the receiving space is preferably divided into an expansion region and a constriction region, wherein the expansion region is formed between the main valve body and the bottom section, and the restriction region is formed between the cylindrical shell section and the piston skirt section, preferably by the annular gap. In particular, the main valve opens on the compression side into the expansion region, whereby expansion of the main volumetric flow is achieved between the main valve and the compression-side auxiliary valve. By re-acceleration of the damper fluid in the constriction region, the damper fluid is diverted in the axial direction after the main valve, thereby reducing vibrational excitations of the cylinder tube and thus noise emissions. By the concentrated free jet of damper fluid emerging from the constriction region, more rapid pressure compensation is furthermore possible in the compression-side working space, and this has a positive effect on the response behavior in the case of direction changes.

According to one aspect of the invention, it is envisaged that the bottom section is connected to the cylindrical shell section by an encircling run-in chamfer, wherein the main volumetric flow runs into the annular gap via the run-in chamfer. In particular, the run-in chamfer serves to direct the main volumetric flow in the direction of the annular gap. By the run-in chamfer, the directional outflow of the damper fluid out of the receiving space, in particular the expansion region, is improved, thereby avoiding or reducing turbulence and thus flow noises of the main volumetric flow.

One aspect of the invention relates to a vibration damper having the valve assembly as already described. The vibration damper is preferably designed and/or suitable for damping vibrations. The vibration damper can be designed as a hydraulic damper, for example. More specifically, the vibration damper can be designed and/or is suitable for a running gear of a vehicle. The vehicle is preferably designed as a commercial vehicle, more specifically for carrying people, e.g. a bus.

### BRIEF DESCRIPTION OF THE DRAWINGS

Further features, advantages and effects of the invention will become apparent from the following description of preferred exemplary embodiments of the invention. In the drawings:

FIG. 1 is a sectional illustration of a vibration;

FIG. 2 is a vibration damper illustrated in the same way as in FIG. 1;

FIG. 3 is a perspective illustration of an auxiliary valve body for the vibration damper; and

FIG. 4 is a perspective illustration of a valve assembly for the vibration damper with the auxiliary valve body.

### DETAILED DESCRIPTION OF THE PRESENTLY PREFERRED EMBODIMENTS

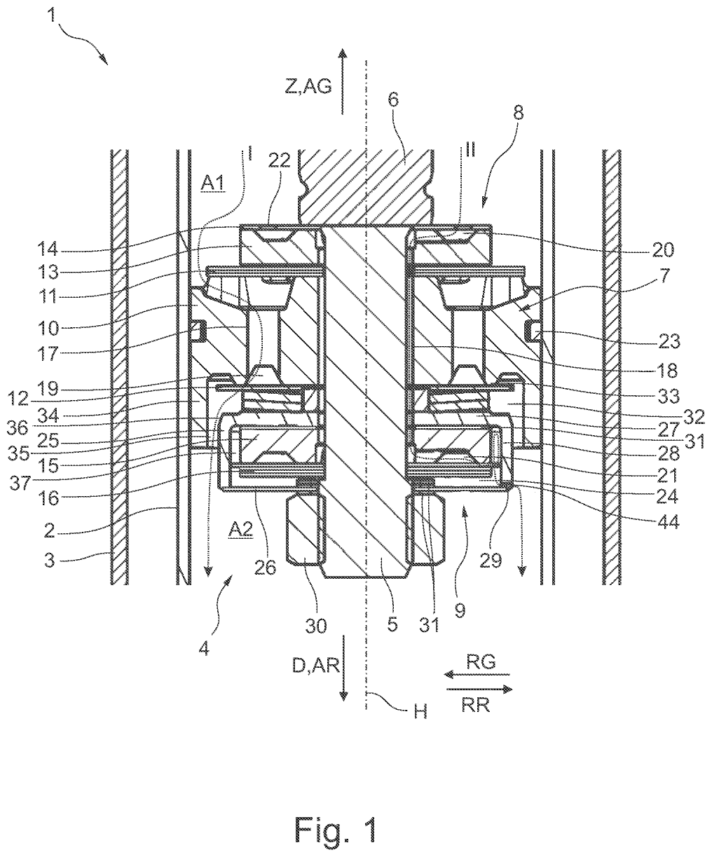

FIG. 1 shows, in a sectional illustration, a vibration damper 1 according to one aspect of the invention of the invention, which is designed and/or suitable for a vehicle, for example. In the illustration shown, the vibration damper 1 is designed as a twin-tube shock damper with a first and a second damper tube 2, 3.

The vibration damper 1 has a valve assembly 4 with a multistage damping force characteristic, which is arranged at the end on a support section 5 of a piston rod 6. The valve assembly 4 is arranged within the first damper tube 2 and can be moved in the axial direction with respect to a main axis H in a tension direction Z and in a compression direction D.

The valve assembly 4 has a main valve 7 as well as a tension-side and a compression-side auxiliary valve 8, 9. The main valve 7 divides the first damper tube 2 into a tension-side and a compression-side working space A1, A2, wherein the tension-side working space A1 is designed as a working space adjacent to the piston rod, and the compression-side working space A2 is designed as a working space remote from the piston rod. The two working spaces A1,A2 are connected hydraulically to one another via the main valve 7 and the two auxiliary valves 8, 9. In this case, the tension-side auxiliary valve 8 is arranged in the tension-side working space A1, and the compression-side auxiliary valve 9 is arranged in the compression-side working space A2.

In a correct assembly condition of the vibration damper, the first and the second working space A1, A2 are filled with a damper fluid, e.g. oil. By way of example, the first working space A1 is bounded, on the one hand, by the main valve 7 in an axial direction AR, in particular the compression direction D, with respect to the main axis H, and, in an opposite axial direction AG, in particular the tension direction Z, is bounded by a piston rod guide (not illustrated). By way of example, the second working space A2 is bounded, on the one hand, by a damper bottom and/or bottom valve (not shown) in the axial direction with respect to the main axis H, and, in the opposite axial direction AG, is bounded by the main valve 7.

The main valve 7 has a main valve body 10 as well as at least one tension-side main valve disk 11 and at least one compression-side main valve disk 12. In this case, the tension-side and the compression-side main valve disk 11, 12 serve to influence, in particular to throttle, a main volumetric flow I of the damper fluid during a movement of the valve assembly 4 in the tension direction Z and the compression direction D. In this case, the main volumetric flow I during a tension movement runs from the tension-side working space A1, via the main valve 7, into the compression-side working space A2 and, during a compression movement, it runs from the compression-side working space A2, via the main valve 7, into the tension-side working space A1.

The tension-side auxiliary valve 8 has a tension-side auxiliary valve body 13 and at least one tension-side auxiliary valve disk 14. In this case, the tension-side auxiliary valve disk 14 serves to influence, in particular to throttle, a secondary volumetric flow II of the damper fluid on the tension side during a movement of the valve assembly 4 in the tension direction Z. In this case, the secondary volumetric flow II during a tension movement runs from the tension-side working space A1, via the two auxiliary valves 8, 9, into the compression-side working space A2.

The compression-side auxiliary valve 9 has a compression-side auxiliary valve body 15 and at least one compression-side auxiliary valve disk 16. In this case, the compression-side auxiliary valve disk 16 serves to influence, in particular to throttle, a secondary volumetric flow II of the damper fluid on the compression side during a movement of the valve assembly 4 in the tension direction Z. During a movement of the valve assembly 4 in the compression direction D, the compression-side auxiliary valve disk 16 serves to prevent backflow, ensuring that the damper fluid flows exclusively or very largely via the main valve 7 into the tension-side working space A1.

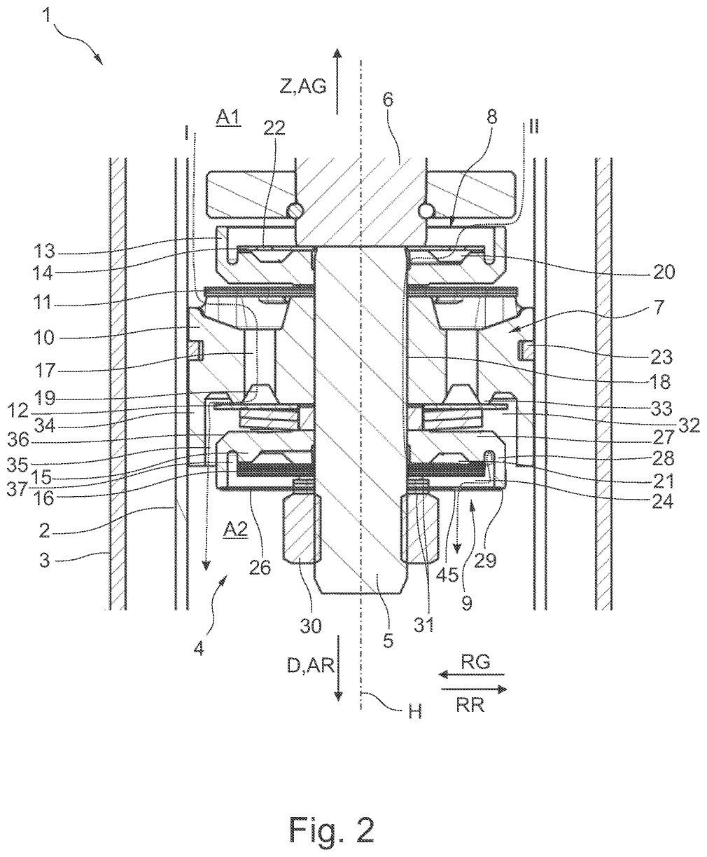

The valve bodies 10, 13, 15 are jointly secured axially on the support section 5, wherein the support section 5 extends through the valve bodies 10, 13, 15. In FIG. 1 and FIG. 2, the support section 5 is formed by an end section, in particular a piston rod pin, of the piston rod 6. In this case, the positions of the valve bodies 10, 13, 15 were chosen in such a way that the main valve body 10 is arranged on the support section 5 axially between the tension-side auxiliary valve body 13 and the compression-side auxiliary valve body 15.

The main valve body 10 has a plurality of tension-side main flow channels 17 and a plurality of compression-side main flow channels (not illustrated), which define the main valve body in the axial direction, in particular passing through it in parallel with one another, wherein the tension-side main flow channels 17 define a flow path for the main volumetric flow I. In this case, the outlet cross sections 19 of the tension-side main flow channels 17 are each influenced or covered by the compression-side main valve disk 12, and the outlet cross sections (not illustrated) of the compression-side main flow channels are influenced or covered by the tension-side main valve disk 11.

The two auxiliary valves 8, 9 are connected fluidically to one another via one or more secondary flow channels 18 connected hydraulically in parallel with the main flow channels 17, and are thus connected hydraulically in series. The secondary flow channels 18 define a flow path for the secondary volumetric flow II. As a result, the flow rate of the damper fluid flowing through the compression-side auxiliary valve 9 is limited by the tension-side auxiliary valve 8. For this purpose, the inlet cross sections 20 of the secondary flow channels 18 are each influenced or covered by the tension-side auxiliary valve disk 14, and the outlet cross sections 21 of the secondary flow channels 18 are each influenced or covered by the compression-side auxiliary valve disk 16. In this case, the secondary flow channels 18 are formed by partial flattened portions on the support section 5, wherein, for this purpose, the support section 5 has a rectangular, in particular square, basic shape, for example.

The tension-side auxiliary valve disk 14 has one or more inflow channels 22, which penetrate the tension-side auxiliary valve disk 14 in the axial direction with respect to the main axis H. In this case, the inflow channels 22 fluidically connect the tension-side working space A1 to the inlet cross sections 20 of the tension-side auxiliary valve body 13. In this case, the inflow channels 22 can have any shape and size, and may be embodied as apertures, bores, or even slots. Through the choice of the shape and size of the inflow channels 22, it is possible to determine the flow rate of the damper fluid.

The main valve 7 furthermore has a sealing device 23, e.g. a piston sealing ring, wherein the main valve body 10 rests in a sealing manner against an inner circumference of the first damper tube 2 via the sealing device 23.

As part of increasing noise requirements in the commercial vehicle sector, especially in passenger transport (bus sector), components such as shock dampers are coming more and more into focus as regards noise generation. The vibration damper 1 proposed is therefore one in which, for noise optimization, an additional damping stage is provided on the compression side by chambering off the compression-side auxiliary valve 9. For this purpose, the compression-side auxiliary valve 9 and the secondary flow channel 18 open within a pressure chamber 24, which is chambered off or delimited fluidically with respect to the compression-side working space A2.

As shown, the chambering of the compression-side auxiliary valve 9 is achieved by two additional components, namely a cylinder pot 25 and a further valve disk 26. In combination, these two components bring about a cascaded, in particular multistage, pressure reduction of the secondary volumetric flow II and surround the entire compression-side auxiliary valve 9. In other words, the compression-side auxiliary valve body 15 and the compression-side auxiliary valve disk 16 are arranged within the pressure chamber 24, with the result that the secondary volumetric flow II runs into the compression-side working space A2 via the pressure chamber 24.

In the axial direction AR, the pressure chamber 24 is bounded by the further valve disk 26, and, in the opposite axial direction AG, it is bounded by a bottom section 27 of the cylinder pot 25. In a radial direction RR, the pressure chamber 24 is bounded by a cylindrical shell section 28, and, in an opposite radial direction RG, it is bounded by the support section 5.

On its axial end, the cylindrical shell section 28 has a valve seat surface 29, on which the further valve disk 26 is supported at the edge in the opposite axial direction AG. The further valve disk 26, which is principally relevant to the function, is designed as an elastically deformable spring disk which, during a tension movement of the valve assembly 4, serves to implement a throttling function and, during a compression movement of the valve assembly 4, serves to implement a nonreturn function.

The valves 7, 8, 9 fixed on the support section 5, the cylinder pot 25 and the further valve disk 26 are braced against one another axially, at least indirectly, by a common securing element 30, wherein the securing element 30 is designed as a piston nut, for example. In this case, one or more compensating disks 31 are arranged in the axial direction between the cylinder pot 25 and the compression-side auxiliary valve body 15, the compression-side auxiliary valve disks 16 and the further valve disk 26 and/or the securing element 30 and the further valve disk 26. By suitable selection of the compensating disks 31, it is possible to set a preload for the compression-side auxiliary valve disks 16 and the further valve disk 26.

The combination of preload and cover disk thickness of the valve disks 16, 26 influences the noise behavior in that it is possible to vary the counter pressure, to achieve an optimum, cascaded pressure reduction and, as a result, to very significantly influence the noise behavior. The defined preload can be set in a simple manner by the compensating disks 31, while, at the same time, it is also possible to compensate for component tolerances. By virtue of the two-part configuration of the chambering (cylinder pot 25/further valve disk 26), one or more of the compensating disks 31 can be inserted variably between the compression-side auxiliary valve body 15 and the cylinder pot 25. As a result, it is possible to guarantee reliable installation of the compression-side auxiliary valve 9.

In FIG. 1, the tension-side auxiliary valve body 13 and the compression-side auxiliary valve body 15 are of substantially the same shape and are arranged in a mirror-inverted manner with respect to one another on the support section 5. In this case, the main valve body 10 has, on the compression side, a cylindrical receiving space 32, in which the compression-side main valve disk 12 is arranged and into which the tension-side main flow channels 17 open. The cylinder pot 25 is arranged at least partially in the receiving space 32, wherein the receiving space 32 is bounded in the axial direction AR by the bottom section 27. In this case, the outside diameter of the cylinder pot 25, in particular of the cylindrical shell section 28, is larger than a diameter of the valve seat surface 33 of the main valve body 10 for the compression-side main valve disk 12.

The main valve body 10 has a piston skirt section 34, which bounds the receiving space 32 in the radial direction RR. An annular gap 35, which encircles the main axis H and opens into the compression-side working space A2, is formed between the cylindrical shell section 28 and the piston skirt section 34. The receiving space 32 thus has an expansion region between the compression-side main valve disk 12 and the bottom section 27 and has an adjoining constriction region formed by the annular gap 35. By the expansion region, it is possible to achieve a pressure reduction by expansion of the main volumetric flow I after the main valve 7 and ahead of the cylinder pot 25. Moreover, by re-acceleration of the damper fluid within the constriction region or annular gap 35, directional discharge of the foamed damper fluid (caused by the opening of the compression-side main valve disk 12) and a reduction in vibrational excitations of the first damper tube 2 can be achieved. By the concentrated free jet emerging from the annular gap 35, a more rapid pressure balance/oil mixing is possible in the compression-side working space A2, and this has a positive effect on the response behavior of the vibration damper 1 in the case of direction changes.

The cylindrical shell section 28 is connected to the bottom section 27 in the axial direction AR by a run-in chamfer 36 encircling the main axis H. Here, the run-in chamfer 36 has the function of directing the main volumetric flow I in the direction of the annular gap 35 after the main valve 7, wherein turbulence and thus flow noises are reduced by the directional outflow of the damper fluid from the main valve 7.

FIG. 2 shows the vibration damper 1 in an alternative embodiment as a further exemplary embodiment of the invention, being illustrated in the same way as in FIG. 1. In this case, the compression-side auxiliary valve body 15, the bottom section 27 and the cylindrical section 28 are manufactured from a common section of material. By virtue of the integral configuration, it is possible to achieve a reduction in the assembly effort and the effects of tolerances on account of the smaller number of components and a reduced number of interfaces.

To further reduce flow noises, an annular trough 37 is formed between the compression-side auxiliary valve body 15 and the cylindrical shell section 28, as illustrated in FIGS. 1 and 2. In this case, the annular trough 37 is formed between the outer circumference of the auxiliary valve body 15 and the inner circumference of the cylindrical shell section 28 and is bounded in the opposite axial direction AG by the bottom section 27. By the annular trough 37, it is possible to achieve a deliberate deflection of the secondary volumetric flow II. In this case, the secondary volumetric flow II is deflected in the opposite axial direction AG when it impinges upon the cylindrical shell section 28, and it is deflected in the axial direction AR within the annular trough 37 in order to calm the fluid flow and increase the flow loss coefficient.

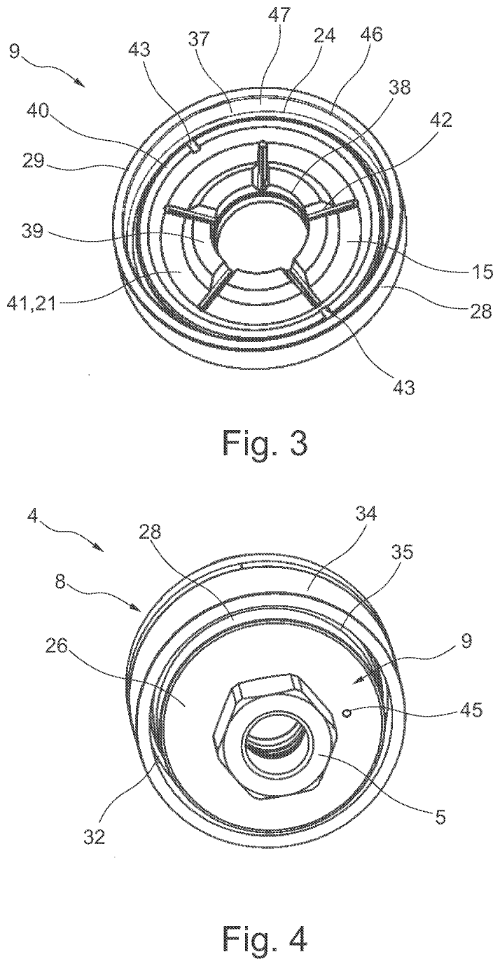

In FIG. 3, the compression-side auxiliary valve 9 is illustrated in a perspective view from below without valve disks 16, 26. The compression-side auxiliary valve body 15 has a central passage opening 38 for the passage of the support section. Moreover, the compression-side auxiliary valve body 15 has at least one radially inner contact surface 39 encircling the passage opening 38, and has a contact edge 40, which runs around radially on the outside in the rim region of the auxiliary valve body 15 and on which the compression-side auxiliary valve disks 16 are axially supported. A further encircling annular trough 41 for optimum distribution of the damper fluid within the compression-side auxiliary valve body 15 is formed between the contact surface 39 and the contact edge 40. In particular, the outlet cross section 21 is defined by the annular trough 41.

Furthermore, the compression-side auxiliary valve body 15 has a plurality of flow channels 42, which extend radially through the contact surface 39 and connect the passage opening 38 to the further annular trough 41. It should be noted that the tension-side auxiliary valve body 13 is of the same construction or identical to the described embodiment of the compression-side auxiliary valve body 15.

In order to enable the vibration damper 1 to be fitted by hand during final assembly of a vehicle, the compression-side auxiliary valve body 15 has one or more, in particular precisely two, radial outflow channels 43, which extend diametrically opposite one another through the contact edge 40. This allows a constant through flow for the damper fluid within the pressure chamber 24, in particular between the two annular troughs 37, 41. By virtue of the arrangement of the radial outflow channels 43, the disk thickness of the compression-side auxiliary valve disks 16 and thus the damper characteristic is not negatively affected.

As an alternative or optional addition, however, it is also possible to provide for at least the compression-side auxiliary valve disk 16 resting against the contact edge 40 to have one or more of the radial outflow channels 43. For this purpose, the outflow channels 43 can be designed as a radial cutout, in particular a slot, for example.

As can be seen from FIG. 1, the cylindrical shell section 28 has one or more further radial outflow channels 44, which extend through the valve seat surface 29. This allows a constant through flow for the damper fluid between the pressure chamber 24 and the compression-side working space A2. By virtue of the arrangement of the further radial outflow channels 44, the disk thickness of the further valve disk 26 is not negatively affected.

Moreover, the further radial outflow channel 44 makes it possible to implement another deflection of the secondary volumetric flow II, as illustrated in FIG. 1, and thus an additional increase in the flow loss coefficient. By virtue of the broken contact circle of the contact edge 40 and the valve seat surface 29, a constant through flow for the secondary volumetric flow II from the tension-side to the compression-side working space A1, A2 is thus ensured, despite the chambered compression-side auxiliary valve 9, and therefore fitting of the vibration damper 1 by hand remains possible.

FIG. 4 shows the valve assembly 4 in a perspective view from below. As an alternative to the further radial outflow channel 44, the further valve disk 26 has an axial outflow channel 45, which penetrates the valve disk 26 in the axial direction. This allows a constant through flow for the damper fluid between the pressure chamber 24 and the compression-side working space A2. The arrangement of the axial outflow channel 45 in the further valve disk 26 prevents a fluid jet directed at the tube wall of the first damper tube 2, thereby reducing the vibrational excitation of the first damper tube 2. In addition, a constant through flow for the secondary volumetric flow II, as shown in FIG. 2, from the tension-side to the compression-side working space A1, A2 is ensured, and therefore fitting of the vibration damper 1 by hand remains possible.

To further reduce flow noises, a radius 46 is formed on an inner edge of the cylindrical shell section 28, as illustrated in FIG. 3. The valve seat surface 29 is connected to an inner lateral surface 47 of the cylindrical shell section 28 by the radius 46.

Alternatively, in an embodiment which is not illustrated, an outflow cross section (radial or axial outflow channel) can optionally also be formed on the main valve 7 (optionally on the auxiliary valve) to produce a constant through flow for the main volumetric flow I. The existing chambering of the compression-side auxiliary valve 9 furthermore has a noise-reducing effect.

The operation of the vibration damper 1 will be explained below in greater detail. Here, the flow profile of the main volumetric flow I and of the secondary volumetric flow II during a tension movement of the valve assembly 4, also referred to as the tension stage, are explained, these influencing the damping force characteristic and causing what are referred to as the damping force characteristic steps. In this context, reference is made during the explanation to FIGS. 1 and 2.

In the tension stage, a pressure difference causes a flow of the damper fluid through the vibration damper 1. During this process, the damper fluid flows along the main volumetric flow I from the first working space Al through the tension-side main flow channels 17 of the main valve body 10. If the quantity of the damper fluid flowing through the main flow channel 17 exceeds a defined limit, the compression-side main valve disk 12 is opened on account of the rising fluid pressure. In this case, the damper fluid flows through a gap which is thus formed between the compression-side main valve disk 12 and the main valve body 10 and collects in the expansion region of the receiving space 32 before it flows out into the compression-side working space A2 via the annular gap 35.

In parallel with the main volumetric flow I, the damper fluid flows along the secondary volumetric flow II from the first working space Al, through the inflow channels 22 in the tension-side auxiliary valve disk 14 of the tension-side auxiliary valve 8, into the further annular trough 41 of the tension-side auxiliary valve body 13 and, via the flow channels 42 thereof, into the secondary flow channel 18. As the pressure difference rises, the damper fluid flows through the secondary flow channel 18, via the flow channels 42 of the compression-side auxiliary valve body 15, into the annular trough 41 thereof. At low speeds of flow or a low volumetric flow, some of the damper fluid can flow off via the outflow channels 43, 44, 45 into the pressure chamber 24 and then into the compression-side working space A2.

As the fluid pressure increases, the compression-side auxiliary valve disks 16 are opened, with the result that the damper fluid flows through a gap that has thus formed between the compression-side auxiliary valve disks 16 and the compression-side auxiliary valve body 15 into the pressure chamber 24. If the quantity of the damper fluid flowing into the pressure chamber 24 exceeds a defined limit, the further valve disk 26 is opened on account of the rising fluid pressure. In this case, the damper fluid flows out of the pressure chamber into the compression-side working space A2 through a gap that has thus formed between the further valve disk 26 and the cylindrical shell section 28.

In the case of a rising pressure, the damping medium flow of the secondary volumetric flow II is thus throttled in a defined manner by the compression-side auxiliary valve disks 16, on the one hand, and also by the further valve disk 26. This multistage pressure reduction allows a reduction in the pressure difference between the emerging damper fluid from the compression-side auxiliary valve 9 and the compression-side working space A2. It is thereby possible to significantly reduce the noise emissions of the compression-side auxiliary valve 9 without having to change the choice of fittings for the main and auxiliary valves 7, 8, 9.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A valve assembly for a vibration damper, comprising:
a main valve, having:
a main valve body; and
at least one main valve disk for influencing a flow resistance of a main volumetric flow;
a tension-side auxiliary valve, having:
a tension-side auxiliary valve body; and
at least one tension-side valve disk for influencing a secondary flow resistance of a secondary volumetric flow on a tension side; and
a compression-side auxiliary valve having:
a compression-side auxiliary valve body; and
at least one compression-side valve disk for influencing the secondary flow resistance of the secondary volumetric flow on a compression side;
a support section for axially securing the main valve and the tension-side auxiliary valve and the compression-side auxiliary valve, wherein the main valve body is arranged on the support section axially between the tension-side auxiliary valve body and the compression-side auxiliary valve body and defines a tension-side and a compression-side working space;
wherein the compression-side auxiliary valve opens into a pressure chamber, which is chambered off relative to the compression-side working space, wherein the pressure chamber is bounded in an axial direction by a further valve disk for influencing the flow resistance of the secondary volumetric flow.

17. The valve assembly as claimed in claim 16, further comprising:
at least one secondary flow channel that connects the tension-side auxiliary valve and the compression-side auxiliary valve to one another fluidically;
wherein, when there is a movement of the valve assembly in a tension direction, the secondary volumetric flow runs from the tension-side working space, via the tension-side auxiliary valve, the secondary flow channel, via the compression-side auxiliary valve into the pressure chamber and from the pressure chamber into the compression-side working space; and
wherein a flow rate of the secondary volumetric flow from the pressure chamber into the compression-side working space is limited by the further valve disk.

18. The valve assembly as claimed in claim 16, wherein the compression-side auxiliary valve body and/or the compression-side auxiliary valve disk have/has at least one radial outflow channel for formation of a radial flow path for the secondary volumetric flow, wherein the secondary volumetric flow runs at least partially in a radial direction via the radial outflow channel into the pressure chamber.

19. The valve assembly as claimed in claim 16, wherein the pressure chamber is bounded in a radial direction by a cylindrical shell section, wherein the cylindrical shell section has on its axial end an encircling valve seat surface for the further valve disk.

20. The valve assembly as claimed in claim 16, further comprising:
at least one axial outflow channel that forms of an axial flow path for the secondary volumetric flow that fluidically connects the pressure chamber to the compression-side working space.

21. The valve assembly as claimed in claim 20, wherein the pressure chamber is connected fluidically to the compression-side working space via at least one further radial outflow channel for formation of a radial flow path for the secondary volumetric flow.

22. The valve assembly as claimed in claim 21,
wherein an encircling annular trough is formed within the pressure chamber between the compression-side auxiliary valve body and a cylindrical shell section, and
wherein a flow direction of the secondary volumetric flow within the pressure chamber is deflected by the annular trough.

23. The valve assembly as claimed in claim 22, wherein at least an inner edge of the cylindrical shell section has a rounding.

24. The valve assembly as claimed in claim 23,
wherein the valve assembly has a cylinder pot for the formation of the pressure chamber, and
wherein the compression-side auxiliary valve body is accommodated in the cylinder pot, and the cylinder pot has the cylindrical shell section.

25. The valve assembly as claimed in claim 23,
wherein the pressure chamber is partially formed by the compression-side auxiliary valve body, and
wherein the compression-side auxiliary valve body has the cylindrical shell section.

26. The valve assembly as claimed in claim 25,
wherein the main valve body has a receiving space on the compression side, and
wherein the main valve opens on the compression side into the receiving space and wherein the receiving space is bounded by a bottom section of the compression-side auxiliary valve in order to influence a flow resistance of the main volumetric flow in the axial direction.

27. The valve assembly as claimed in claim 26, wherein either the compression-side auxiliary valve body or a cylinder pot has the bottom section.

28. The valve assembly as claimed in claim 27,
wherein the receiving space is bounded in a radial direction by a piston skirt section, and
wherein an encircling annular gap for fluidically connecting the receiving space to the compression-side working space is formed between the cylindrical shell section and the piston skirt section.

29. The valve assembly as claimed in claim 28, wherein the bottom section is connected to the cylindrical shell section by an encircling run-in chamfer, wherein the main volumetric flow runs into the annular gap via the run-in chamfer.

30. A vibration damper comprising:
a valve assembly, comprising:
a main valve, having:
a main valve body; and
at least one main valve disk for influencing a flow resistance of a main volumetric flow;
a tension-side auxiliary valve, having:
a tension-side auxiliary valve body; and
at least one tension-side valve disk for influencing a secondary flow resistance of a secondary volumetric flow on a tension side; and
a compression-side auxiliary valve having:
a compression-side auxiliary valve body; and
at least one compression-side valve disk for influencing the secondary flow resistance of the secondary volumetric flow on a compression side;
a support section for axially securing the main valve and the tension-side and the compression-side auxiliary valve, wherein the main valve body is arranged on the support section axially between the tension-side auxiliary valve body and the compression-side auxiliary valve body and defines a tension-side and a compression-side working space;
wherein the compression-side auxiliary valve opens into a pressure chamber, which is chambered off relative to the compression-side working space, wherein the pressure chamber is bounded in an axial direction by a further valve disk for influencing the flow resistance of the secondary volumetric flow.
